(19) United States
(12) Patent Application Publication
(10) Pub. No.: US 2014/0081186 A1
(43) Pub. Date: Mar. 20, 2014

(54) EXERCISE DEVICE WITH FULL RANGE OF MOTION HANDLE

(71) Applicant: Gary R. Paris, Raleigh, NC (US)

(72) Inventor: Gary R. Paris, Raleigh, NC (US)

(73) Assignee: Adaptive Therapies LLC

(21) Appl. No.: 13/623,154

(22) Filed: Sep. 20, 2012

(51) Int. Cl. A61H 1/02; A63B 21/06; A63B 22/12

(52) U.S. Cl. 601/33; 482/62; 482/93; 482/139

(57) ABSTRACT

The present invention relates to an exercise machine for setting exercise in six degrees of motion. In particular, it exercises the shoulder more thoroughly and quickly than previously available.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to exercise equipment. In particular, the present invention relates to exercise equipment that improves the range of motion obtainable with appendage actuated exercise equipment.

2. Description of Related Art

The use of exercise devices such as weight training and cardiovascular training machines include a repeated movement that moves over a designated path. For weight training there is a resistance provided by weights, bands, or the like to render the movement more difficult and intensify the exercise. With cardio type or shoulder rehabilitation type exercise, frequently handles are grasped and rotated in a circular fashion much like pedals on the bike either by hand or foot. The movement itself dictates the muscles or muscle groups involved in the exercise.

One great problem with exercise equipment in general is that handles, foot loops, or the like are usually fixed such that parallel back and forth or parallel circular motions are achieved. This is usually also done in a perpendicular to the user's chest fashion with arms spread apart shoulder width. These fixed handles limit the way the muscles are exercised and is not adequate to real life situations since in real life pushing, pulling, and rotation motions can end up in any of the 6 degrees of movements allowed by limbic rotation. For example, an individual may need to push an object with arms spread wide apart, thus using muscles differently than shoulder width apart on most machines. For all around training, current hand driven exercise machines are limited by design to at most those that raise and lower the handles and do not function to completely train and/or rehabilitate the individual. Using both hands on either side of a wheel to rotate the wheel limits the movements of the machine to exercising in a single plane and greatly limits the potential of the machine in both shoulder rehabilitation and upper body development.

### BRIEF SUMMARY OF THE INVENTION

The present invention relates to devices which allow the user to set various ranges of motion other than just shoulder width.

Accordingly, in one embodiment of the invention there is an exercise machine adjustable for different ranges of motion for a user to perform an exercise while grasping a handle of the machine comprising:
a. one or two upright arms;
b. an adjustment device attached to each of the one or two upright arms each device capable of
   i. adjusting and locking vertically relative to the upright device;
   ii. adjusting and locking horizontally relative to the upright device; and
   iii. adjusting and locking rotationally around an axis that is perpendicular to the upright device; and
c. a handle and adjustable shaft attached to the adjustment device for grasping by the user and performing the exercise.

Another embodiment of the present invention is a method for rehabilitating a shoulder of an individual having a shoulder problem comprising exercising on a cardio spinning machine comprising:
a. one or two upright arms;
b. an adjustment device attached to the one or two upright arms each device capable of
   i. adjusting and locking vertically relative to the upright device;
   ii. adjusting and locking horizontally relative to the upright device; and
   iii. adjusting and locking rotationally around an axis that is perpendicular to the upright device; and
c. a handle and adjustable shaft attached to the adjustment device for grasping by the user and performing the cardio spinning exercise.

### BRIEF DESCRIPTION OF THE DRAWINGS

FIG. 1 is a front view of a machine of the present invention.

FIGS. 2a-2c show a side view of the rotational function of the present invention.

FIG. 3 is a top view of the horizontal arms and a rotational embodiment.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

As used herein the term “comprising” is not intended to limit inventions to only claiming the present invention with such comprising language. Any invention using the term comprising could be separated into one or more claims using “consisting” or “consisting of” claim language and is so intended.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “exercise machine” refers to an indoor type cycling device wherein the user grasps one or two handles and rotates them singly or together as one would pedal a bicycle with their feet (either opposing or non-opposing handles). The rotation (pedaling) can be done under resistance or no resistance and clockwise or counter clockwise. An exercise machine in another embodiment, can be a weight machine wherein one or two handles are grasped and weights or resistance applied to wheels and a repetition movement made to strengthen the muscle being exercised. In one embodiment, the handles are for grasping by the hands and in other embodiments are adapted to be used by one or two feet. The exercise is done periodically, and where to repair an injury or an upper body problem, periodically until there is acceptable improvement.

As used herein the phrase “different ranges of motion” refers to being able to fix the motion of the exercise machine in one of six degrees of freedom of movement for each hand or foot. While normal machines are fixed and operate shoulder width and perpendicular to the user, the present invention allows for adjustment (and locking in place) of any type of movement in order to strengthen the muscles all over and not limited to a single plane. As used herein “adjustable” means the user can set the six degrees of motion and lock them in place during use for each hand or foot. Range of motion extends to the ability to shorten and lengthen the shaft from the handle to the center of the wheel, changing the length of the shaft changes the degree of angular movement of the shoulder during the exercise.

As used herein a “user” refers to a person exercising on an exercise machine either hand cycling, foot cycling, or weight lifting using the one or two handles of the exercise machine.

As used herein the term “upright arms” refers to vertical support for the adjustment device of the present invention. In one embodiment, they are upright tubings (any cross section such as square or tubular) capable of supporting the weight of the adjustment device which will be mounted thereon. They can be steel or steel alloy but could also be a polymer, a carbon compound, or the like. One skilled in the art of building exercise machines could build and chose materials based on the description and example drawings herein. In one embodiment, the upright is generally perpendicular to the ground and high enough (tall enough) to mount the adjustment device at a level the user can grasp overhead or down to waste level properly/comfortably. The arms can, in one embodiment, be attached to a lower portion horizontal arm in which two arms meet in a center portion of the machine and approximately under the user's shoulders (e.g. underneath a seat in the device). In one embodiment, the arms are pivotally adjustable either with a pin, such as a spring loaded pin, and hole means of fixing with a pivot in the center or any other means for pivoting the arms radially. When pivoted, they can position the handles as close together or as far apart as desired. The horizontal arms can, in one embodiment, be rotated and backed in place about a total of 180 degrees, or in one embodiment the range of human movement. In one embodiment there is only one stand alone stationary upright and only one resistance wheel with the ability to raise and lower. The handle/handles on the wheel are rotated using only one hand. As long as the seat can move toward and away from the resistance wheel and lock into place and swivel left and right and lock in place, this results in the ability to exercise the shoulders and arms to the range of normal human movement but will also be limited to exercising in a single plane (without angular variation).

As used herein the term “handle” refers to a device for grasping by the user during an exercise on an exercise machine. One skilled in the art knows how to make handles and if the device is a hand cycling (cardio spinning) type exercise machine where the handles rotate or weight lifting/training type device, those skilled in the art can adapt handles based on the disclosure herein and standard exercise machine handles. The device can be for use by both hands/feet or just one hand or foot.

As used herein the term “adjustable shaft” refers to a device that functions as a adjustable radius of the wheel extending from the center of the wheel to the handle. While turning the wheel: as the radius increases the amount of shoulder angle (shoulder movement) increases, as the radius decreases the shoulder angle (shoulder movement) decreases.

In the present invention, each handle and adjustable shaft is attached to an adjustment device. As used herein the “adjustment device” is a device attached/mounted to the upright arms which allows the adjustment of the position and movement of the attached handles in 6 degrees of freedom including configurations and variations thereof. Therefore, when hand cycling or the like, instead of the normal shoulder width apart straight forward direction of movement, the user can set the handles in combinations and various degrees of movement to exercise and strengthen all the muscles of the upper body and not just those connected with a straight movement. The 6 degrees of movement (up, down, right, left, toward and away plus any angular combination) is made possible by having each adjustment device operated with only one hand (using two hands at the same time means using two separate adjustment devices).

The adjustment device consists of a device that first can adjust and lock vertically relative to the uprights, second it is capable of adjusting and locking horizontally relative to the upright device, and lastly adjusting and locking rotationally around an axis that is perpendicular to the upright device.

As used herein the “adjustment and locking means” of the present invention can be one of several different types for mounting and locking on or relative to the upright. For example, a series of holes with a pin, such as a spring loaded pin, can be utilized where a guide slides on the upright, or in other embodiments a guide rod is mounted and the adjustment is made by sliding along a bar, for example, horizontally. Rotating devices can adjust rotationally via rotation around a central axle.

In one embodiment shown in the drawings, the uprights are attached to a horizontal member on a lower portion of the uprights. In one further embodiment the horizontal end is attached to the bottom of the upright. The opposite end of the horizontal piece not attached to the upright is further capable of rotating around a central pivot point with two uprights. Each upright is attached to a pivot point and in one embodiment, the same pivot point.

Resistance for the machine can be of any established type currently in use for a hand driven wheel or foot cycling on an exercise machine, e.g. electric, magnetic, mechanical, etc. Such devices are well known. A device, such as a gas spring assembly or the like, is connected to a cable extending upward over the pulley attached on top of the vertical arm 3, then extending downward and attaching to the top of the adjustment device 15. The purpose of this is twofold 1) to provide a stabilizing lifting force so that the adjustment device can be safely raised and lowered and 2) by mounting it on the opposite side of the vertical arm and using a pulley one is able to substantially reduce the length size of the vertical arm.

In one embodiment of the present invention, the machine has a seat which is adjustable vertically, horizontally (toward and away from the stationary resistance wheel), and rotationally around a center pivot point of the chair.

The present device can be made from the traditional materials utilized to build exercise type devices. Therefore, structural steel for uprights or other frame components, plastic pieces, stainless steel, and the like all can be utilized.

The present device can be utilized especially for the exercise and treatment of a rotator cuff injury, shoulder problems or athletic training of the upper body. The present invention allows for more aggressive rehabilitation of the shoulder during a recovery phase or in a gym setting to build muscle and advance muscle tone and range of motion. Where a single arm is to be treated, only a single stationary upright support with attachments to raise and lower the adjustable device and a seat that swivels and locks into position would be all that is necessary (or the use of one of the handles of the two handle design shown).

In another embodiment the seat and or machine can be tilted back to push the user back into the seat more effectively during use. The present device then effectively shows greater precision control while exercising or while taking measurements (e.g. measure the progress of the rehabilitation).

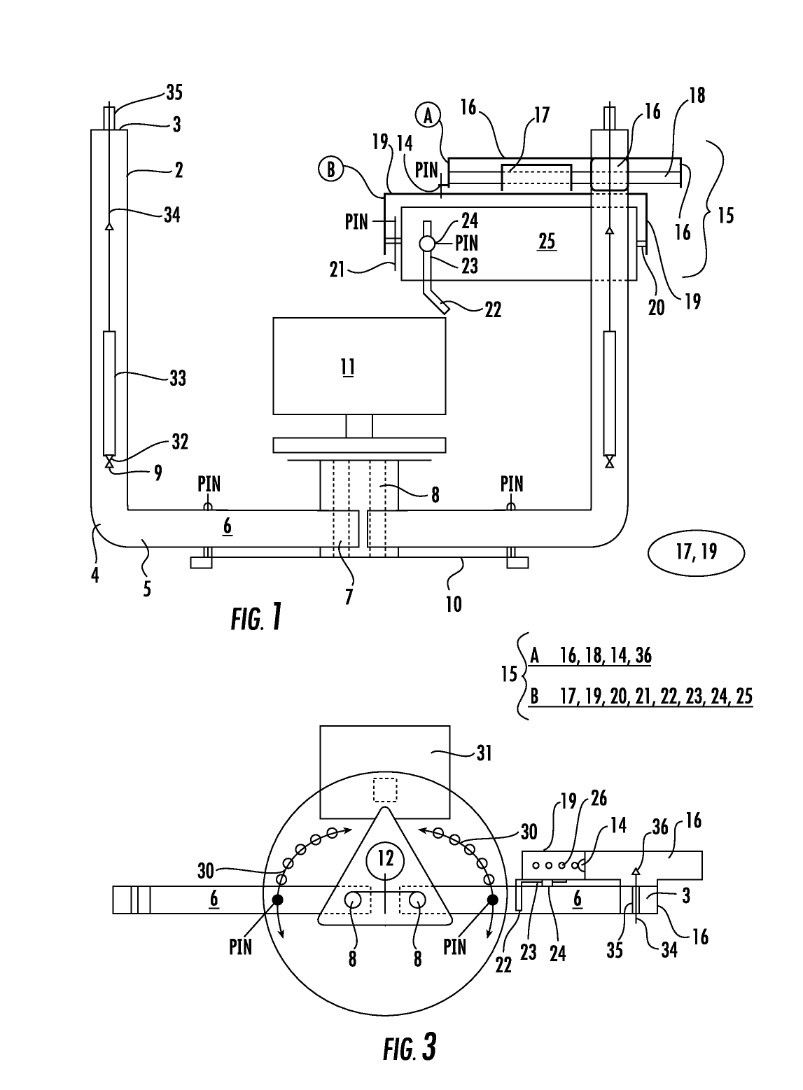

Now referring to the drawings, FIG. 1 is a frontal view of an embodiment of the present invention with two handles, however, a single handle is also covered. Machine 1 comprises a pair of upright arms 2 which have a top end 3 and a bottom end 4. The bottom end 4 is attached to distal end 5 of horizontal bar 6. The proximal end 7 of horizontal bar 6 is attached to pivot point 8. A system 10 joins each of the horizontal arms 6 in order to keep them aligned or adjusted. In this view a seat 11 embodiment is shown which is capable of up, down as well as tilting motions using the skill in the art for such mechanisms. Seat post 12 is shown in this view.

In this view only one adjustment device 15 is shown but in practice there would be one on each upright 2 adjusted in mirror image for use by both hands during exercise. For simplicity a cycling type machine for use in the treatment of a rotator cuff problem is shown but clearly other versions could be made from this disclosure and examples. In one embodiment, and using the same adjustable device on a single stationary upright support with the ability to raise and lower and with a seat that can swivel left and right and lock into position makes possible the 6 degrees of freedom found including combinations and variations for normal human movement, the same as on the two adjustable device machine.

Adjustment device 15 is divided into two parts A and B. A consists of a vertically adjusting bracket 16 which slides up and down upright 2 and held in place, i.e. locked, by any means such as holes in the upright and bracket through which a pin, such as a spring loaded pin, is placed. This bracket extends away from the upright 2 and is bent downward at both ends supporting two horizontal bars 18. There are two small brackets on the main bracket 16. The first bracket 14 is closest to the user which supports the placement of the vertical locking pin, the second small bracket is a connection point 36 on the top of main bracket 16 and toward the middle (balance point) for attachment to the cable and counterweight system. B consists of device 17 which rides horizontally along the two bars 18 (the two bars pass through device 17). Device 17 is attached to large bracket 19 which is bent downward at both ends to support axle 20 at both ends. Axle 20 can rotate at both connections with bracket 19. Axle 20 is connected (no movement) to rotational device 21 and mounting box 25 on the front end (users end) and on the opposite end to mounting box 25. A horizontal pin placement extending through bracket 19 using the pin hole provided 29a on the front end and into a corresponding receiving hole 29 on the rotational device 21 will secure the rotation of the mounting box 25 around the axle 20 (other figures more clearly depict this aspect of the embodiment).

The handle 22 is used by the person exercising and in this embodiment is turned in a circular means for a cycling type exercise. It is connected to an adjustable shaft 23 and into a through adjustment/locking device 24 which will allow the shaft to change lengths and be locked into place with a pin type connection. It is mounted to mounting box 25 which provides resistance by an internal resistance device (within the skill of the art).

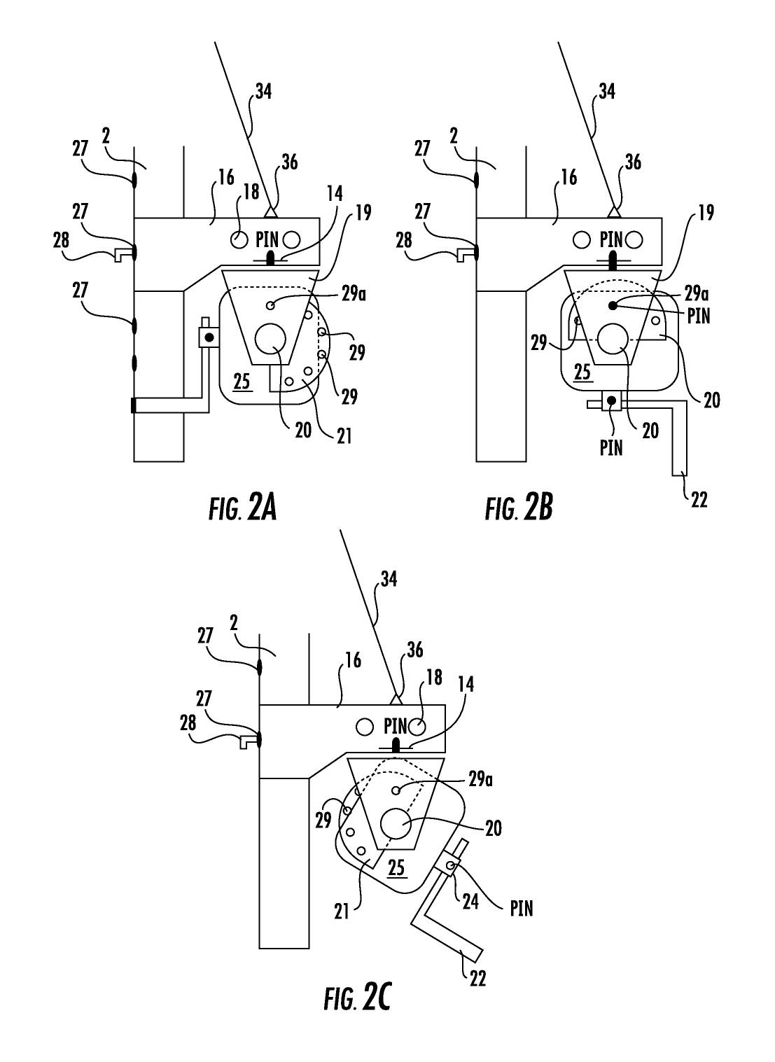

FIGS. 2a, 2b and 2c depict the rotationally adjusting and locking device 21 from a side view so that its operation can more easily be seen. In FIG. 2a vertical bracket 16 can be seen attached to upright 2. Holes 27 are aligned on both the bracket 16 and upright 2 and locking pin 28 inserted to hold bracket in place. Rotational device 21 has multiple holes 29 which match to a hole 29a in the horizontal bracket 19 and by use of a pin, such as a spring loaded pin, can be held in various positions as shown in FIGS. 2a, 2b and 2c. Accordingly, handle 22 is placed in different positions based on the position of the rotational device 21. Note that in this view, the rotational device axle 20 can be seen in which the device 25 can rotate clockwise or counter clockwise around 20 and be pinned in place, the device B 25 also moves horizontally (forward or backward) along support tubes 18 and pinned in place using a pin, such as a spring loaded pin, extending through bracket A 14 and into the receiving holes on bracket B 19.

FIG. 3 is a top view showing the horizontal arms 6 each attached to a bar/pivot point 8 which allows the L shaped upright/horizontal bar combination to rotate according to arrows 30 and locked into place with a pin. Foot rest 31 can also be seen and the seat 11 has been removed for clarity but seat post 12 from a top view is shown. The top of the adjustment device is also shown showing the bracket A 14 for the pin placement into receiving holes B 26 to lock the horizontal movement. Bracket 36 is also shown for the cable attachment on the opposite side of the gas spring assembly.

The counterweight consists of a small connection bracket 9 toward the bottom of the upright 2. A gas spring assembly 33 or the like with connector 32 is attached to bracket 9. The movable end of the gas spring assembly extends upward where it connects with cable 34. The cable extends upward over the pulley 35 and down to the adjustment device 15. The attachment for the cable on the adjustment device can be found on bracket 16 toward a balance point and labeled bracket 36.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. An exercise machine adjustable for different ranges of motion for a user to perform an exercise while grasping a handle of the machine comprising:
a) one or two upright arms;
b) an adjustment device attached to each of the one or two upright arms each device capable of
i. adjusting and locking vertically relative to the upright device;
ii. adjusting and locking horizontally relative to the upright device; and
iii. adjusting and locking rotationally around an axis that is perpendicular to the upright device; and
c) a handle and adjustable shaft attached to the adjustment device for grasping by the user and performing the exercise.

2. The exercise machine according to claim 1 wherein the one or more handles rotate a one or more wheels to perform an exercise.

3. The exercise machine according to claim 2 wherein a single wheel is rotated with a single hand.

4. The exercise machine according to claim 1 wherein the exercise is selected from the group comprising weight training and cardio spinning.

5. The exercise machine according to claim 1 wherein the adjustment device adjusts vertically by a pin and hole locking means wherein the holes are positioned in series on the uprights.

6. The exercise machine according to claim 1 wherein the adjustment device adjusts horizontally via sliding along bars mounted horizontally relative to the uprights.

7. The exercise machine according to claim 1 wherein the adjustment device rotates axially via rotation around a central axle.

8. The exercise machine according to claim 1 wherein a pin and hole are used as a locking mechanism to position the adjustment device.

9. The exercise machine according to claim 1 wherein the uprights are attached to a horizontal member at a lower position of the upright and further capable of rotating around a central pivot point each of the horizontal members is attached to.

10. The exercise machine according to claim 1 wherein the handle is positionally adjustable on the shaft.

11. The exercise machine according to claim 1 wherein the machine further has a seat which is adjustable in at least one direction of vertically, horizontally, and rotationally around a center pivot point of the chair.

12. The exercise machine according to claim 1 wherein there is a counterweight system for compensating for the weight of the adjustment device moving up or down the upright arms.

13. The exercise machine according to claim 11 wherein the counterweight is a pulley and gas spring assembly operated counterweight system.

14. The exercise machine according to claim 1 wherein there is one upright arm with the seat that can swivel and move towards and away from the handle.

15. A method of rehabilitating a shoulder injury or exercising a shoulder of an individual having a shoulder problem comprising exercising on a cardio spinning machine comprising:
a) one or two upright arms;
b) an adjustment device attached to the one or two upright arms each device capable of
i. adjusting and locking vertically relative to the upright device;
ii. adjusting and locking horizontally relative to the upright device; and
iii. adjusting and locking rotationally around an axis that is perpendicular to the upright device; and
c) a handle and adjustable shaft attached to the adjustment device for grasping by the user and performing the cardio spinning exercise.

16. The method according to claim 14 wherein the shoulder injury is a rotator cuff problem.

17. The method according to claim 14 wherein the shaft is positionally adjustable.

18. The method according to claim 14 wherein the exercise is periodic and continues until there is an acceptable improvement.

19. The method according to claim 14 wherein a single shoulder is exercised.

20. The method according to claim 14 wherein a single handle spins a single wheel with a single hand of the individual.
